(19) United States
(12) Patent Application Publication
(10) Pub. No.: US 2025/0214531 A1
(43) Pub. Date: Jul. 3, 2025

(54) INFORMATION PROCESSING DEVICE

(71) Applicant: TOYOTA JIDOSHA KABUSHIKI KAISHA, Toyota-shi (JP)

(72) Inventors: Keizoh KAWAGUCHI, Okazaki-shi (JP); Kazumi AONO, Tokyo (JP); Yuki NAKAGAWA, Toyota-shi (JP)

(73) Assignee: TOYOTA JIDOSHA KABUSHIKI KAISHA, Toyota-shi (JP)

(21) Appl. No.: 18/891,377

(22) Filed: Sep. 20, 2024

(30) Foreign Application Priority Data
Dec. 27, 2023 (JP) 2023-220748

(51) Int. Cl. B60R 25/04; H04W 4/029

(52) U.S. Cl. CPC B60R 25/04; H04W 4/029; B60R 2025/0415

(57) ABSTRACT

In response to the vehicle being parked, a control unit configured to perform acquiring information regarding security in a predetermined area including a position at which the vehicle is parked, and outputting information regarding a setting of a remote immobilizer of the vehicle in response to the security in the predetermined area being in a predetermined state.

### CROSS-REFERENCE TO RELATED APPLICATION

This application claims priority to Japanese Patent Application No. 2023-220748 filed on Dec. 27, 2023, incorporated herein by reference in its entirety.

### BACKGROUND

### 1. Technical Field

The present disclosure relates to an information processing device.

### 2. Description of Related Art

It is known that a remote immobilizer function setting request signal is transmitted from a vehicle to a server device via a telecommunication line when a mobile terminal of a user is located in a registered area (see, for example, Japanese Unexamined Patent Application Publication No. 2021-188279 (JP 2021-188279 A)).

### SUMMARY

An object of the present disclosure is to cause a remote immobilizer to function appropriately.

One aspect of the present disclosure is an information processing device including a control unit configured to:

acquire, in response to parking of a vehicle, information on security in a predetermined area including a location where the vehicle is parked; and
output information on setting of a remote immobilizer of the vehicle when the security in the predetermined area is in a predetermined state.

The present disclosure can also be regarded as an information processing method in which a computer executes the processing of the above information processing device. Moreover, the present disclosure can also be regarded as an information processing program that causes a computer to execute the information processing method or a non-transitory storage medium storing the information processing program.

According to the present disclosure, the remote immobilizer can function appropriately.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a system according to a first embodiment;

FIG. 2 is a block diagram schematically illustrating an example of a configuration of each of a vehicle, a user terminal, and a server constituting the system according to the first embodiment;

FIG. 3 is a flow chart showing a process of setting a remote immobilizer in the server according to the first embodiment; and

FIG. 4 is a flowchart illustrating a process of collecting security information from a plurality of vehicles in the server according to the second embodiment.

### DETAILED DESCRIPTION OF EMBODIMENTS

An information processing device according to an aspect of the present disclosure includes a control unit configured to set or release a remote immobilizer. The remote immobilizer is a function of prohibiting the activation of the vehicle by remote control. Note that prohibition of activation of the vehicle by remote control is hereinafter referred to as setting of a remote immobilizer, and permission of activation of the vehicle by remote control is hereinafter referred to as releasing of the remote immobilizer. By setting the remote immobilizer, the vehicle does not accept an input of a signal or the like from the outside, so that the vehicle cannot be activated. Therefore, when the remote immobilizer is set, not only the unauthorized key but also the authorized key possessed by the user is not authenticated by the vehicle, and thus the vehicle cannot be started.

Note that “activation of the vehicle” means a state in which the vehicle is allowed to travel in accordance with an operation by the driver. “Vehicle activation” is a notion that involves, for example, starting the engine responsive to IG on (ON of an IG switch) in a vehicle having an engine. Alternatively, “vehicle activation” is a concept including, for example, battery electric vehicle (BEV), plug-in hybrid electric vehicle (PHEV), hybrid electric vehicle (HEV), power-on (activation of controllers (for example, ECU, etc.) that control the entire vehicle), and the like.

The control unit included in the information processing device according to one aspect of the present disclosure acquires information related to security in a predetermined area including a position where the vehicle is parked in response to the vehicle being parked. The predetermined area is an area where the position where the vehicle is parked is considered to be equivalent to the state of security. This region corresponds to, for example, a region partitioned by an administrative section or a region partitioned by a mesh. The information on public safety is information on an event in which a vehicle is damaged by a crime, and may be information on, for example, an incidence or number of crimes, an incidence or number of stolen vehicles, an incidence or number of stolen vehicles, and the like. Further, as another example, the information related to public safety may be a notification of the occurrence of a crime transmitted from another vehicle or the number of such notifications. For example, the information regarding security may be information regarding a rate at which the alarm device is activated or a number at which the alarm device is activated in the vehicle.

Further, the control unit outputs information related to the setting of the remote immobilizer of the vehicle in response to the security in the predetermined area being in a predetermined state. The predetermined state is, for example, a state in which the vehicle itself is stolen or an article inside the vehicle is stolen. For example, when the crime incidence rate is equal to or higher than the predetermined rate, it can be said that the security is in the predetermined state. In this case, there is a high possibility that the vehicle will be damaged by the crime. Therefore, the control unit outputs information related to the setting of the remote immobilizer. Outputting the information about the remote immobilizer settings includes transmitting a command to set the remote immobilizer to the vehicle, or transmitting a notification to the terminal of the user of the vehicle or the vehicle that recommends the setting of the remote immobilizer of the vehicle. In this way, the remote immobilizer can be made to function suitably even in a region other than the region registered by the user.

Hereinafter, an embodiment of the present disclosure will be described with reference to the drawings. The hardware configuration, the module configuration, the functional configuration, and the like described in the following embodiments are not intended to limit the technical scope of the disclosure only thereto unless otherwise specified.

### First Embodiment

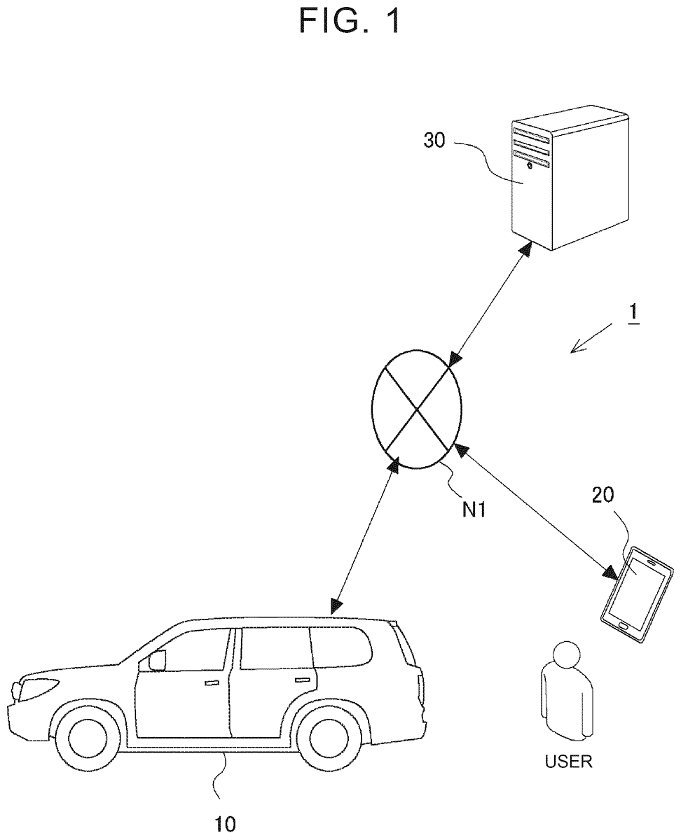

FIG. 1 is a diagram showing a schematic configuration of a system 1 according to the present embodiment. The system 1 includes a vehicle 10, a user terminal 20, and a server 30. The vehicle 10 is a vehicle associated with the user terminal 20. The server 30 sets and releases the remote immobilizer. When the remote immobilizer is set, activation of the vehicle 10 is prohibited. In a state in which the remote immobilizer is set, the vehicle 10 cannot be activated even by a legitimate user, for example. On the other hand, when the remote immobilizer is released, the user can activate the vehicle 10. The user can request the server 30 to set and release the remote immobilizer via the user terminal 20.

In addition, the server 30 sets a remote immobilizer in response to the fact that the security in the predetermined area including the position where the vehicle 10 is parked is in the predetermined state. As another example, the server 30 may transmit a notification recommending the setting of the remote immobilizer to the user terminal 20 or the vehicle 10. By setting the remote immobilizer, the third party cannot activate the vehicle 10, and thus the security effect is enhanced. If the server 30 automatically sets the remote immobilizer, the user does not need to operate the user terminal 20 to set the remote immobilizer.

The vehicle 10, the user terminal 20, and the server 30 are connected to each other by a network N1. The network N1 is, for example, a world-wide public communication network such as the Internet, and a wide area network (WAN) or other communication networks may be adopted. In addition, the network N1 may include a telephone communication network such as a mobile phone network and a wireless communication network such as Wi-Fi (registered trademark). Although FIG. 1 illustrates one vehicle 10 as an example, there may be a plurality of vehicles 10. Further, there may be a plurality of users and user terminals 20 depending on the number of vehicles 10.

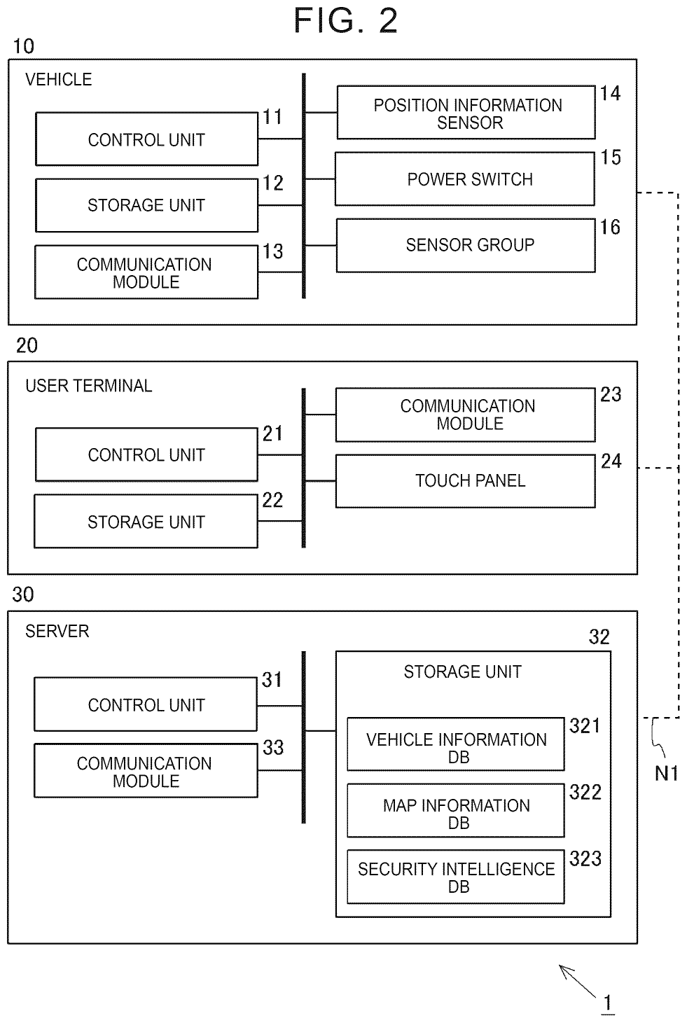

FIG. 2 is a block diagram schematically showing an example of the configuration of each of the vehicle 10, the user terminal 20, and the server 30 constituting the system 1 according to the first embodiment. The server 30 can be configured as a computer including a processor (such as a CPU, GPU), a main storage device (such as a RAM, ROM), and a secondary storage device (such as an EPROM, a hard disk drive, and a removable medium). The secondary storage device stores an operating system (OS), various programs, various tables, and the like. By executing the program stored in the auxiliary storage device, it is possible to realize each function (software module) that matches a predetermined purpose, as will be described later. However, some or all of the modules may be realized as hardware modules by, for example, hardware circuitry such as an ASIC, FPGA.

The server 30 includes a control unit 31, a storage unit 32, and a communication module 33. The control unit 31 is an arithmetic unit that realizes various functions of the server 30 by executing a predetermined program. The control unit 31 can be realized by, for example, a hardware processor such as a CPU. The control unit 31 may include a RAM, ROM, a cache memory, and the like. Details of the control unit 31 will be described later.

The storage unit 32 is a unit that stores information, and is configured by a storage medium such as a RAM, a magnetic disk, or a flash memory. The storage unit 32 stores a program executed by the control unit 31, data used by the program, and the like. In addition, a database (vehicle information DB 321, map information DB 322, and security information DB 323) is constructed in the storage unit 32.

The control unit 31 acquires information on the vehicle 10 (hereinafter, also referred to as vehicle information). The vehicle information is information for associating the vehicle 10 with the user terminal 20. In the vehicle data, a vehicle ID that is an identifier unique to the vehicle 10, a user ID that is an identifier unique to the user, and user terminal ID that is an identifier unique to the user terminal 20 are stored. This information is previously registered by the user in the server 30 using the user terminal 20. Upon acquiring the vehicle information, the control unit 31 stores the vehicle information in the vehicle information DB 321.

The map information DB 322 stores map information, including map data including geographic locations and Point of Interest (POI) information such as text and photographs indicating the properties of respective points on the map data. In addition, the map information DB 322 stores, for example, information on administrative divisions and regional meshes. Note that the map information DB 322 may be provided from another system connected to the network N1, for example, a Geographic Information System (GIS).

The security information DB 323 stores information on security corresponding to each region (hereinafter, also referred to as security information). The region may be, for example, a region defined by an administrative division or a regional mesh. The security information may be generated based on, for example, information transmitted from each vehicle 10. For example, when there is a suspicious behavior in the vehicle 10, it may be transmitted as security information from the vehicle 10 to the server 30. When the alarm device is activated, the control unit 31 may determine that there is a suspicious behavior. The alarm device may be, for example, a device that operates when a person illegally enters the vehicle 10 or when vibration occurs in the vehicle 10. When the alarm device is activated in each vehicle 10, the server 30 is notified together with the position information. Then, the control unit 31 of the server 30 that has received the notification stores the information on the position and the time in the security information DB 323. That is, the security information DB 323 may store information on a position and a time at which the alarm device is activated.

As another example, the control unit 31 may acquire the crime incidence rate (for example, the crime incidence rate per predetermined population) in each region from the servers of the administrative organ and store the acquired crime incidence rate in the security information DB 323. That is, the security information DB 323 may store information on crime incidence rates corresponding to respective regions.

The communication module 33 is a communication interface for connecting the server 30 to the network N1. The communication module 33 may be configured to include, for example, a network interface board, a wireless communication interface for wireless communication, and the like. The server 30 can perform data communication with the vehicle 10 and the user terminal 20 via the communication module 33.

The vehicle 10 has a function of a remote immobilizer. The vehicle 10 includes a control unit 11, a storage unit 12, a communication module 13, a position information sensor 14, a power switch 15, and a sensor group 16. These components are connected to each other by a CAN bus, which is a bus of an in-vehicle network. These components may be components such as a Data Communication Module (DCM), a head unit, a navigation system, an air conditioner system, and a traveling system.

The control unit 11 can be realized by, for example, a hardware processor such as a CPU. In addition, the control unit 11 may be configured to include a RAM, Read Only Memory (ROM), a cache memory, and the like. The storage unit 12 is a unit that stores information, and is configured by a storage medium such as a RAM, a magnetic disk, or a flash memory. The storage unit 12 stores a program executed by the control unit 11, data used by the program, and the like.

The communication module 13 is a communication unit for connecting the vehicles 10 to the network N1. In the present embodiment, vehicles 10 can communicate with other devices (for example, server 30) over a network N1 using a mobile communication service such as 3G, LTE, 5G, 6G. The position information sensor 14 acquires position information (for example, latitude and longitude) of the vehicle 10. The position information sensor 14 is, for example, a Global Positioning System (GPS) receiver, a radio communication unit, or the like. The power switch 15 is a switch that activates the vehicle 10 or stops the function of the vehicle 10 when the user presses the switch. Each time the user presses the power switch 15, the power on and the power off are switched. The power-on state is a state in which the vehicle 10 is activated, and is a state in which the vehicle 10 can travel. The power-off state is a state in which the function of the vehicle 10 is stopped, and is a state in which the vehicle 10 cannot travel (parked state).

The sensor group 16 includes a sensor that detects vibration generated in the parked vehicle 10 or a sensor that detects that a person has entered the parked vehicle 10.

In addition, when receiving a command for setting a remote immobilizer from the server 30, the control unit 11 of the vehicle 10 sets the remote immobilizer and prohibits the activation of the vehicle 10. Prohibiting the activation of the vehicle 10 includes not accepting an input from the user to the vehicle 10, shutting off the supply of power necessary for the operation of the vehicle 10, prohibiting the start of the engine, and the like. For example, even when the user presses the power switch 15 while the remote immobilizer is set, the control unit 11 does not execute a process of activating the vehicle 10.

In addition, the control unit 11 of the vehicle 10 permits the activation of the vehicle 10 when a command to release the remote immobilizer is received from the server 30. In this state, when the user presses the power switch 15, the control unit 11 executes a process of activating the vehicle 10.

The control unit 11 of the vehicle 10 acquires position information acquired by the position information sensor 14 at predetermined intervals, associates the acquired position information with the vehicle ID, and transmits the acquired position information to the server 30. When the power switch 15 is pressed and the vehicle 10 is in the power-off state, the control unit 11 of the vehicle 10 transmits parking information, which is information indicating that the vehicle 10 is parked, to the server 30. The parking information includes position information acquired by the position information sensor 14. The control unit 11 of the vehicle 10 notifies the server 30 that an abnormality has occurred when the sensor group 16 detects an abnormality while the vehicle 10 is parked.

In addition, when receiving a notification recommending the setting of the remote immobilizer from the server 30, the control unit 11 of the vehicle 10 causes an image indicating that the setting of the remote immobilizer is recommended to be displayed on a display of the vehicle 10, causes a warning sound to flow from a speaker of the vehicle 10, or causes a warning light of the vehicle 10 to blink.

The user terminal 20 is a terminal used by a user of the vehicle 10, and is, for example, a smart phone, a tablet terminal, a wearable terminal, or a Personal Computer (PC). In the user terminal 20, for example, application software (hereinafter, referred to as a remote immobilizer application) capable of setting and releasing a remote immobilizer is installed. The user terminal 20 includes a control unit 21, a storage unit 22, a communication module 23, and a touch panel 24. The control unit 21, the storage unit 22, and the communication module 23 of the user terminal 20 have the same configuration as the control unit 11, the storage unit 12, and the communication module 13 of the vehicle 10. The touch panel 24 is a device that receives an input from a user and a device that presents information to the user. The touch panel 24 is a touch panel display including, for example, a Liquid Crystal Display (LCD) or an Electro luminescence (EL) panel.

The control unit 21 of the user terminal 20 activates the remote immobilizer application when the user taps an icon for activating the remote immobilizer application on the touch panel 24. In the remote immobilizer application, when there is a predetermined input for setting the remote immobilizer, the control unit 21 generates a request for setting the remote immobilizer and transmits the request to the server 30. In addition, when there is a predetermined input for releasing the remote immobilizer in the remote immobilizer application, the control unit 21 generates a request for releasing the remote immobilizer and transmits the request to the server 30. In this way, the user can request the server 30 to set and release the remote immobilizer via the user terminal 20.

In addition, when receiving a notification recommending the setting of the remote immobilizer from the server 30, the control unit 21 of the user terminal 20 causes the touch panel 24 to display an image indicating that the setting of the remote immobilizer is recommended.

Upon receiving a request for setting a remote immobilizer from the user terminal 20, the control unit 31 of the server 30 generates a command for setting a remote immobilizer and transmits the command to the vehicle 10. The vehicle 10 is a vehicle associated with the user terminal 20 in the vehicle information DB 321. In addition, upon receiving a request to release the remote immobilizer from the user terminal 20, the control unit 31 of the server 30 generates a command to release the remote immobilizer and transmits the command to the vehicle 10.

When receiving the parking information from the vehicle 10, the control unit 31 of the server 30 determines whether to set a remote immobilizer based on the position information included in the parking information. At this time, the control unit 31 specifies the parking position of the vehicle 10 based on the position information included in the parking information. Further, the control unit 31 refers to the security information DB 323 and extracts the security status in a predetermined area including the parking position of the vehicle 10. For example, the control unit 31 extracts the crime occurrence rate in the predetermined area or the number of operations of the alarm device received from the other vehicle 10 in the predetermined area. Then, it is determined that the remote immobilizer is set in response to the state of security being a predetermined state. At this time, the control unit 31 determines that the state of security is a predetermined state when the crime occurrence rate is equal to or greater than the predetermined rate or when the number of operations of the alarm device is equal to or greater than the predetermined number. Further, in response to determining that the remote immobilizer is to be set, the control unit 31 generates a command for setting the remote immobilizer and transmits the command to the vehicle 10. As described above, in response to the security in the predetermined region including the parking position of the vehicle 10 being in the predetermined state, the control unit 31 outputs information related to the setting of the remote immobilizer of the vehicle 10. Therefore, the remote immobilizer can be automatically set without the user operating the user terminal 20.

As another example, the control unit 31 transmits, to the user terminal 20 or the vehicle 10, a notification recommending the setting of the remote immobilizer in response to the determination that the remote immobilizer is to be set. At this time, the control unit 31 may transmit, to the user terminal 20, a command for causing the touch panel 24 of the user terminal 20 to display a recommendation to set a remote immobilizer. In addition, the control unit 31 may display, on the display of the vehicle 10, a recommendation to set a remote immobilizer, or may transmit a command to cause a sound to that effect to flow, or blink a warning light to the vehicle 10. In this way, the user can be encouraged to configure the remote immobilizer. When the remote immobilizer is set, the user needs to operate the user terminal 20 in order to release the remote immobilizer, which takes time and effort. Therefore, it is conceivable that the user does not want to set the remote immobilizer. On the other hand, if the user can determine whether or not to set the remote immobilizer, the convenience of the user can be improved.

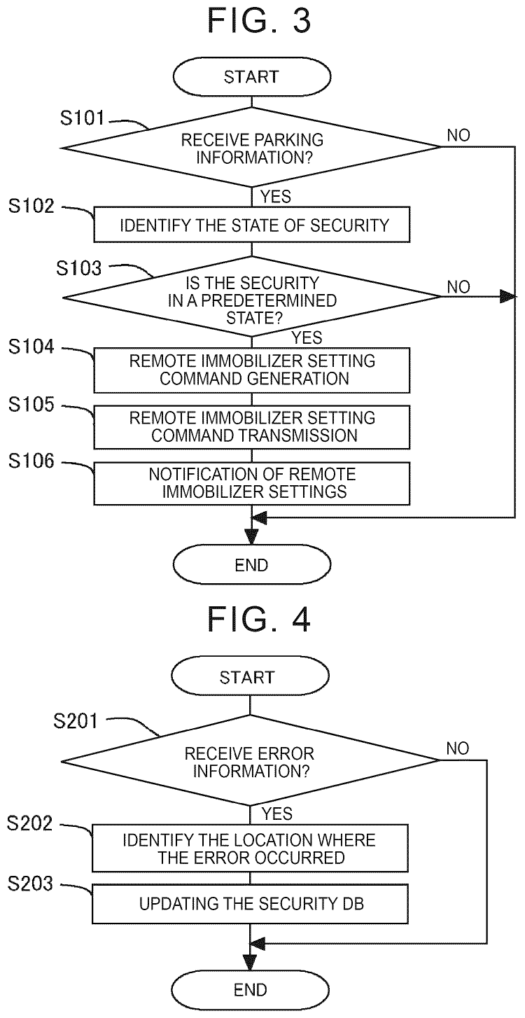

FIG. 3 is a flowchart illustrating a process of setting a remote immobilizer in the server 30 according to the first embodiment. The flowchart illustrated in FIG. 3 is executed in the server 30 at predetermined time intervals. Note that the description will be given on the assumption that necessary information is stored in each database. In addition, it is assumed that the security information DB 323 stores information on crime incidence rates corresponding to respective regions.

In S101, the control unit 31 determines whether or not parking data has been received from the vehicles 10. If the control unit 31 makes an affirmative determination in S101, the process proceeds to S102, and if a negative determination is made, the routine ends.

In S102, the control unit 31 specifies the security status corresponding to the position where the vehicles 10 are parked while referring to the security information DB 323. Information on the parking position of the vehicle 10 is included in the parking information. The control unit 31 specifies a region corresponding to the parking position. This area is classified in the security information DB 323. Then, the control unit 31 extracts the crime incidence rate corresponding to the region from the security information DB 323.

In S103, the control unit 31 determines whether or not the security state specified in S102 is a predetermined state. The predetermined state is a security state in which it is recommended to set a remote immobilizer. When the crime incidence rate is equal to or greater than the predetermined rate, the control unit 31 determines that the security state is the predetermined state. The predetermined rate is stored in advance in the storage unit 32 as a crime occurrence rate that is recommended to set a remote immobilizer. If the control unit 31 makes an affirmative determination in S103, the process proceeds to S104, and if a negative determination is made, the routine ends.

In S104, the control unit 31 generates a command for setting a remote immobilizer. In S105, the control unit 31 transmits a command for setting the generated remote immobilizer to the vehicles 10. In S106, the control unit 31 transmits a notification in which the remote immobilizer is set to the user terminal 20. The user terminal 20 is the user terminal 20 associated with the vehicle 10 in the vehicle information DB 321. The control unit 21 of the user terminal 20 that has received this notification, for example, causes the touch panel 24 to display that the remote immobilizer has been set.

In the flowchart illustrated in FIG. 3, a command for setting a remote immobilizer is transmitted from the server 30 to the vehicle 10. As another example, a notification recommending the setting of the remote immobilizer may be transmitted from the server 30 to the user terminal 20 or the vehicle 10. In this case, in S104, the control unit 31 generates a notification for recommending the setting of the remote immobilizer, and in S105, the control unit 31 transmits a notification for recommending the setting of the generated remote immobilizer to the user terminal 20 or the vehicle 10. In addition, when the control unit 31 transmits a notification recommending the setting of the remote immobilizer to the user terminal 20, S106 process is omitted. In the user terminal 20 that has received the notification recommending the setting of the remote immobilizer, the control unit 21 causes the touch panel 24 to display an image corresponding to the notification recommending the setting of the remote immobilizer. Further, in the vehicle 10 that has received the notification recommending the setting of the remote immobilizer, the control unit 11 causes the display provided in the vehicle 10 to display an image corresponding to the notification recommending the setting of the remote immobilizer, to play a sound to that effect, or to blink a warning light indicating this.

As described above, according to the present embodiment, when the vehicle 10 is parked in a place where public safety is relatively poor, the control unit 31 of the server 30 automatically sets the remote immobilizer or transmits a notification recommending the setting of the remote immobilizer to the user terminal 20 or the vehicle 10, so that the remote immobilizer can suitably function. Therefore, it is possible to prevent the vehicle 10 from being damaged by theft or the like.

### Second Embodiment

In the flowchart illustrated in FIG. 3, the security state is determined based on the crime incidence rate, but as another example, the security state may be determined based on information received from another vehicle 10.

FIG. 4 is a flowchart illustrating a process of collecting security information from a plurality of vehicles in the server 30 according to the second embodiment. The flowchart illustrated in FIG. 4 is executed in the server 30 at predetermined time intervals. In S201, the control unit 31 determines whether or not an anomaly has been received from the vehicles 10. The abnormality occurrence information is information indicating that the vehicle 10 has been damaged by a crime, and includes, for example, a notification that the alarm device of the vehicle 10 has been activated. This notification includes information about the location and time. If the control unit 31 makes an affirmative determination in S201, the process proceeds to S202, and if a negative determination is made, the routine ends. In S202, the control unit 31 specifies the position of the vehicle 10 in which an anomaly has occurred. The position of the vehicle 10 is included in the abnormality occurrence information. In S203, the control unit 31 updates the security information DB 323 by storing the specified abnormality occurrence position and the time at which the abnormality has occurred in the security information DB 323. Note that the control unit 31 that has received the abnormality occurrence information may notify the user terminal 20 associated with the vehicle 10 that the abnormality has occurred.

When the security information DB 323 is generated by the flow chart shown in FIG. 4, in S102 shown in FIG. 3, the control unit 31 specifies the number of alarms that have been activated within a predetermined period from the parking position of the vehicle 10 within a predetermined period when the security state is specified. The predetermined distance is a distance that is considered to be equivalent to the position where the vehicle is parked and the state of security. The region within the predetermined distance is an example of the predetermined region. Further, the predetermined time period is a time period in which a third party, which is a cause of the operation of the alarm device, may still be close to the vehicle 10, and is, for example, several hours to one day. The number extracted by the control unit 31 corresponds to a security state.

Then, in S103, the control unit 31 determines whether or not the number of cases specified in S102 is equal to or greater than a predetermined number when determining whether or not the security is in a predetermined condition. The predetermined number is a number indicating that the security is in a predetermined state, and may be, for example, one.

In this way, the remote immobilizer can be set in response to damage such as theft occurring in real time. Instead of the number of alarms activated, a remote immobilizer may be set based on the rate at which the alarms activated. For example, the number of alarms activated with respect to the number of vehicles 10 parked within a predetermined time within a predetermined distance from the parking position of the vehicle 10 is calculated as the rate at which the alarm device is activated. When the calculated rate is equal to or greater than the predetermined rate, the control unit 31 may set the remote immobilizer.

### Other Embodiments

The above-described embodiment is merely an example, and the present disclosure may be appropriately modified and implemented without departing from the scope thereof. The processes and means described in the present disclosure can be freely combined and implemented as long as no technical contradiction occurs. Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Non-transitory computer-readable storage media include, for example, any type of disc, read only memory (ROM), random access memory (RAM), EPROM, EEPROM, magnetic cards, flash memory, optical cards, any type of media suitable for storing electronic instructions. Any types of disks include magnetic disks (floppy (registered trademark) disks, hard disk drives (HDD), etc.), optical disks (CD-ROM, DVD disks, Blu-ray disks, etc.), etc.

What is claimed is:

1. An information processing device comprising a control unit configured to
acquire, in response to parking of a vehicle, information on security in a predetermined area including a location where the vehicle is parked, and
output information on setting of a remote immobilizer of the vehicle when the security in the predetermined area is in a predetermined state.

2. The information processing device according to claim 1, wherein the control unit is configured to
acquire information on an incidence of crimes in the predetermined area as the information on the security, and
output the information on the setting of the remote immobilizer of the vehicle when the incidence of crimes in the predetermined area is equal to or greater than a predetermined incidence.

3. The information processing device according to claim 1, wherein the control unit is configured to transmit, to the vehicle, a command to set the remote immobilizer of the vehicle as the information on the setting of the remote immobilizer of the vehicle.

4. The information processing device according to claim 1, wherein the control unit is configured to transmit, to a terminal of a user of the vehicle or to the vehicle, a notification for recommending the setting of the remote immobilizer of the vehicle as the information on the setting of the remote immobilizer of the vehicle.

5. The information processing device according to claim 1, wherein the control unit is configured to generate the information on the security in the predetermined area based on pieces of information on the security and pieces of information on locations that are collected from a plurality of vehicles, and store the information on the security in the predetermined area in a storage unit.
